(19) United States
(12) Patent Application Publication
(10) Pub. No.: US 2025/0371248 A1
(43) Pub. Date: Dec. 4, 2025

(54) Systems and Methods for Cascading Document Updates

(71) Applicant: Chekable Inc., Oakland, CA (US)

(72) Inventors: Ashutosh Chapagain, Bloomington, IN (US); Nipun Kumar, Oakland, CA (US)

(21) Appl. No.: 18/935,396

(22) Filed: Nov. 1, 2024

Related U.S. Application Data
(60) Provisional application No. 63/653,668, filed on May 30, 2024.

(51) Int. Cl. G06F 40/166; G06F 40/106

(52) U.S. Cl. CPC G06F 40/166; G06F 40/106

(57) ABSTRACT

The various implementations described herein include methods and devices for cascading document edits. In one aspect, a method includes receiving an initial input from a user that is a request to generate a document having a document type and generating a document using content output from a large language model. An editable document is presented to the user. The method further includes receiving a user edit to the document and identifying other locations within the document that require change based on current content in the document and the user edit. The method includes automatically generating prompts for the large language model based on the user edit within the document and generating an updated document that includes suggestions to update the document with the content from the large language model at the identified locations in the document. An editable updated document is presented to the user.

### RELATED APPLICATIONS

This application claims priority to U.S. Provisional Application Ser. No. 63/653,668, filed May 30, 2024, titled “Systems and Methods for Cascading Document Updates,” which is incorporated by reference herein in its entirety.

### TECHNICAL FIELD

The disclosed implementations relate generally to content creation and more specifically to systems and methods of using artificial intelligence to implement automatic document updates.

### BACKGROUND

Existing systems and methods for generating content using artificial intelligence often cannot handle complex document structures efficiently, potentially leading to errors or increased time in organizing the text. Additionally, systems focusing on text input and rules application may not effectively manage complex multimedia content, limiting their usefulness in diverse document creation scenarios. Many systems also lack advanced content management features such as integration with large language models for automated content recommendations and editing, which are essential for addressing inefficiencies in multimedia document management. Furthermore, manual prompting is a key input method between content creators and large language models, which requires additional work to think about prompts. Another limitation of conventional prompt-based content creation tools such as chatting or co-pilot user interfaces is that content or a part of content is entirely regenerated, making it hard for users to change only specific terms, phrases, or sentences embedded in the document (e.g., requiring manually updating parts of the documents).

### SUMMARY

Disclosed implementations reduce manual prompting in the document creation process, making document creation efficient and not having the user task switching between document creation versus prompting.

The present disclosure introduces a novel system that integrates several advanced features to significantly enhance the content creation process. This system utilizes a large language model to generate content recommendations directly within the user interface. The system also tracks and manages the location of content within the document and can auto-generate and revise document-specific prompts when working with the large language model to generate new suggestions. Furthermore, it incorporates auto-editing, auto-proofing, and auto-content-generation capabilities, leveraging large language models to understand and improve the document continuously. The present disclosure also involves dynamic updating of document contexts and templates in response to user interactions, enhancing the relevance and accuracy of the content presented. This comprehensive integration of technologies represents a significant advancement over existing methods, providing a more efficient, user-friendly, and adaptable solution for multimedia document creation and management.

In accordance with some implementations, a method is performed at a computing device having memory and one or more processors. The method includes receiving an initial input from a user and determining that the initial input corresponds to a request to generate a document having a document type. The method also includes generating, by a prompt engine, one or more first prompts for a large language model. The one or more first prompts are generated based on (i) the initial input and (ii) a document template for the document type. The method further includes receiving first content generated by the large language model based on the one or more first prompts; generating, by a document content manager, a document based on (i) the first content received from the large language model and (ii) the document template; and presenting the content for the document to the user. The content is arranged and presented to the user in accordance with the document template. The method further includes receiving a user edit to the document; identifying, by the prompt engine, one or more locations within the document that require change based on current content in the document and the user edit; and generating, by the prompt engine, one or more second prompts for the large language model. The one or more second prompts are generated based on the user edit and correspond to the one or more locations within the document. The method also includes receiving second content generated by the large language model based on the one or more second prompts and generating, by the document content manager, an updated document that includes one or more suggestions to update the document with the second content at the one or more locations. The one or more suggestions are generated based on the second content. The method further includes presenting the updated document. The one or more suggestions are presented in accordance with the one or more locations in the document and the one or more suggestions are visually emphasized relative to original content in the document.

In some implementations, a computing device includes one or more processors, memory, a display, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

In various circumstances, the systems and methods for automatically cascading updates in a document of the present disclosure has one or more of the following advantages over currently available systems. First, in accordance with some implementations, the system leverages one or more large language models to generate content for the document. The method automatically generates prompts based on the user's input, thus eliminating the need for the user to have advance skills in prompt generation to receive useful outputs from the large language model. Also, when the user provides additional input to the document in the form of edits within the document, the system automatically keeps track of changes to the document, the location of content in the document, and areas of the document that need to be updated in response to the user's edits. The system then automatically generates new prompts for the large language model(s) based on the user's edits and the areas of the document that need further updating. The system presents generated content from the large language model to the user in the form of suggestions within the document. Since this process is happening as user edits are received, there is a rapid call and response style of editing that allows edits to a document to be quickly and automatically propagated throughout the entire document without requiring a complete manual revision by the user.

Thus, methods and systems are disclosed for cascading updates in a document.

Such methods and systems may complement or replace conventional methods and systems of content generation using large language models.

### BRIEF DESCRIPTION OF THE DRAWINGS

For a better understanding of the aforementioned systems, methods, and graphical user interfaces, as well as additional systems, methods, and graphical user interfaces that provide cascading document updates, reference should be made to the Description of Implementations below, in conjunction with the following drawings in which like reference numerals refer to corresponding parts throughout the figures.

FIG. 1A illustrates an example of a computer system for executing a document authoring application in accordance with some implementations.

FIG. 1B illustrates an example of a computer system for executing an on-device document authoring application in accordance with some implementations.

FIG. 1C illustrates an example of a computer system for executing a cloud-based document authoring application in accordance with some implementations.

FIG. 2 is a block diagram of an example computing device in accordance with some implementations.

FIG. 3 illustrates a workflow for handling user input in accordance with some implementations.

FIG. 4A is a block diagram of a document type determination workflow in accordance with some implementations.

FIG. 4B is a block diagram of a document generation workflow in accordance with some implementations.

FIG. 5 is a block diagram of a document editing workflow in accordance with some implementations.

FIGS. 6A-6D illustrate examples of user interfaces for receiving user input and presenting recommendations to a user in accordance with some implementations.

FIGS. 7A-7D provide a flowchart of a method for cascading document updates in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

A system for document management and content generation leverages large language models to automatically generate new content based on a user's input. In accordance with some implementations, the system automatically generates prompts for a large language model based on user inputs to a document, tracks the context of the document and the location of content within the document, and can automatically identify areas of the document that require a change based on user edits to the document. User inputs may be multimodal. For example, user inputs may include, and are not limited to, any combination of text, images, motion, audio, video, sensors. User inputs can be provided by any means, including but not limited to, user interfaces. As a user continues to provide edits to the document, the system continues to develop its understanding of the context of the document and can use this information to generate better prompts for the large language model, thereby achieving useful outputs from the large language model to be presented as suggestions within the document. Thus, inconsistencies in content can be automatically detected by the system, allowing the system to aid the user by providing a self-healing document and ensuring that content maintains consistency throughout the document.

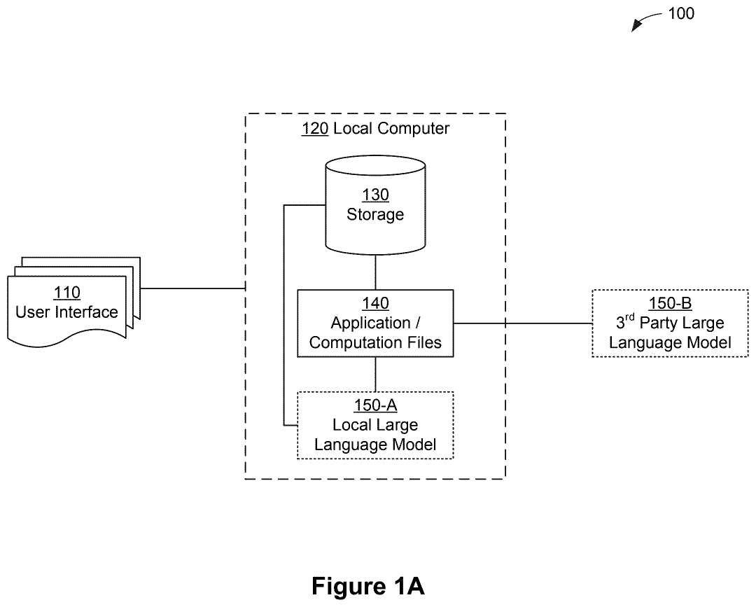

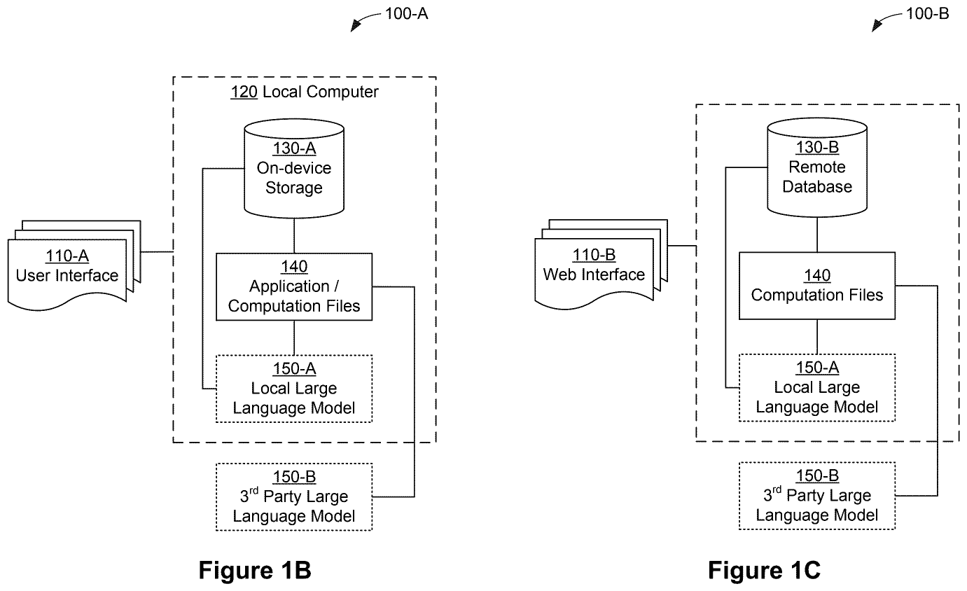

FIG. 1A illustrates an example of a computer system 100 in accordance with some implementations. The computer system 100 includes a user interface 110, a local computer 120, and a third-party large language model 150-B for executing a document authoring application in accordance with some implementations. The document authoring application may perform functions related to, and not limited by, any of: a text editor, word processor, presentation slides editor, and a code editor (a programming application, integrated development environment).

The user interface 110 is configured to receive inputs from a user and present outputs to the user. It serves as the primary interaction point for the user to provide one or more inputs and to view generated content and recommendations. The local computer 120 interfaces with and includes storage 130 (e.g., local storage or a database) and a local large language model 150-A. The storage 130 is used to store data. The application and/or the computation files 140 contain the software and algorithms necessary to execute the methods described herein. The local large language model 150-A may be a commercially available, cloud-based large language model, or a self-hosted large language model on a hard drive or on a private network. When the local large language model 150-A is on a hard drive, the local large language model 150-A can be used offline (e.g., with no internet connection, or with no cloud connection). Additionally, the local computer 120 can interface with a third-party large language model 150-B, which is external to the local computer 120. This model may be used to leverage computational resources or specialized language models that extend beyond the capabilities of the local computer 120.

In some implementations, as shown in FIG. 1B, the computer system 100-A utilizes an on-device application, and the local computer 120 includes application files 140 and on-device storage 130-A. The local computer 120 interfaces with the user via a user interface 110-A. In some implementations, the user interface 110-A is provided via an operating system or via one or more applications running on the computer system 120. The on-device storage 130-A facilitates execution of the application and can access the local large language model 150-A without requiring internet connectivity. In some embodiments, the system may interface with the third-party large language model 150-B, allowing for additional functionality or additional computational resources when needed.

In some implementations, as shown in FIG. 1C, the computer system 100-B utilizes cloud-based applications. The computer system 100-B includes a web-interface 110-B, which connects to a remote database 130-B. Computational resources 140 and the local large language model 150-A (in this case, a self-hosted large language model) are also part of the cloud infrastructure, enabling the processing and generation of content based on user inputs. The computer system 100-B can also interface with a third-party large language model 150-B to leverage external computational capabilities or additional LLM functionalities. The cloud-based setup allows for scalable and flexible access to the application and its features, accommodating various user needs and computational demands.

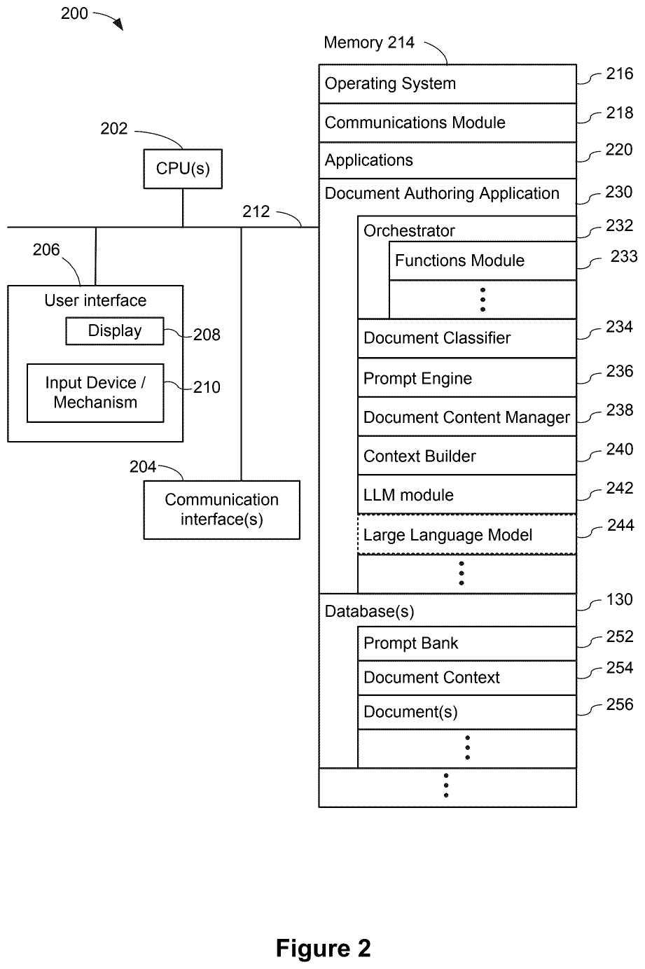

FIG. 2 is a block diagram of a computing device 200 in accordance with some implementations. Various examples of the computing device 200 include a desktop computer, a laptop computer, a tablet computer, and other computing devices (e.g., IT or OT devices) that have a processor capable of running a document authoring application 230. The computing device 200 typically includes one or more processing units/cores (CPUs) 202 for executing modules, programs, and/or instructions stored in the memory 214 and thereby performing processing operations; one or more network or other communications interfaces 204; memory 214; and one or more communication buses 212 for interconnecting these components. The communication buses 212 may include circuitry that interconnects and controls communications between system components.

In some implementations, the computing device 200 includes a user interface 206 comprising a display device 208 and one or more input devices or mechanisms 210. In some implementations, the input device/mechanism includes a keyboard. In some implementations, the input device/mechanism includes a “soft” keyboard, which is displayed as needed on the display device 208, enabling a user to “press keys” that appear on the display 208. In some implementations, the display 208 and input device/mechanism 210 comprise a touch screen display (also called a touch sensitive display).

In some implementations, the memory 214 includes high-speed random-access memory, such as DRAM, SRAM, DDR RAM or other random-access solid-state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternatively the non-volatile memory device(s) within the memory 214, includes a non-transitory computer-readable storage medium. In some implementations, the memory 214, or the computer-readable storage medium of the memory 214, stores the following programs, modules, and data structures, or a subset thereof:
an operating system 216, which performs procedures for handling various basic system services and hardware dependent tasks;
a communications module 218, which may be used for connecting the computing device 200 to other computers and devices via the one or more communication network interfaces 204 (wired or wireless) and one or more communication networks, such as the Internet, other wide area networks, local area networks, metropolitan area networks, and so on;
applications 220, which perform particular tasks or sets of tasks for a user (e.g., word processors, media players, web browsers, and communication platforms);
a document authoring application 230, which assists users in document generation and editing. The document authoring application 230 includes one or more of:
   an orchestrator 232, which delegates, processes, manages, and monitors the sequence of events, functions, and operations, and coordinates interaction between different components or modules within the document authoring application 222. The orchestrator may also turn processes on or off based on other processes and user inputs. The orchestrator includes one or more modules configured to execute various aspects of the orchestrator's job. For example, the orchestrator 232 may include a functions module 233 configured to call other functions. In another example, the orchestrator 232 may include an events module that is configured to monitor the sequence of events;
   a document classifier 234, which determines what type of document is being created. A document type may be multimedia document that may be determined by the theme of its purpose and format. A document type may provide subject matter context for a large language model. Examples of a document type include, but are not limited to: a magazine, a work of fiction, a work of nonfiction, specific legal documents such as a patent application, a policy document, code for computer applications, an audiobook, a transcript, a comic book, or movie script;
   a prompt engine 236, which generates prompts for large language models based on document context, document classification, and user input. In some implementations, the prompt engine uses a large language model to generate prompts. In some implementations, the prompt engine utilizes document templates to generate prompts that are part of an agentic prompting process. Document templates may be boilerplate document types used as is or modified by a large language model to further generate relevant prompts for generating document content. A document template may include prompts, format, styling, structure, tips, resources for a large language model to come up with further prompts by applying the context of the document being created by the user. In some implementations, the prompt engine 236 may generate prompts that utilize the orchestrator 232 to retrieve (e.g., via the functions module 233) information from tools such as, but not limited to, any of: a search engine service, a retrieval-augmentation generation process and proprietary data sources;
   a document content manager 238, which oversees the creation and updating of document content. In some implementations, the document content manager 238 tracks headings, sub-headings, paragraphs, which content was entered by the user, and which content was created by the large language model. It manages (i) the order of facts, (ii) concepts in the document, and (iii) relationships between different components, and determines where to insert new content across the document based on any edits made by the user to any part of the document;
   a context builder 240, which constructs and maintains context (e.g., knowledge about the document and references about the concepts in the document) for the document. In some implementations, the context builder 240 is constantly running in the background and automatically updates the context throughout the document content generation and editing process;
   a large language model module 242, which communicates with (e.g., sends information to and receives information from) third-party large language models 150-B; and
   a locally hosted large language model 244; and
one or more databases 130, which are used by the applications 220 and/or the document authoring application 230. The one or more databases 130 include: (i) a prompt bank 252, which includes a plurality of document templates that can be used by the document authoring application 230 based on document type, (ii) document context 254, which is generated by the context builder 240 for each document and is continually updated as the document evolves with user edits, and (iii) documents 256 generated by the document authoring application 230.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 stores a subset of the modules and data structures identified above. Furthermore, the memory 214 may store additional modules or data structures not described above (e.g., an auto-prompt engine).

Although FIG. 2 shows a computing device 200, FIG. 2 is intended more as a functional description of the various features that may be present rather than as a structural schematic of the implementations described herein. In practice, and as recognized by those of ordinary skill in the art, items shown separately could be combined and some items could be separated.

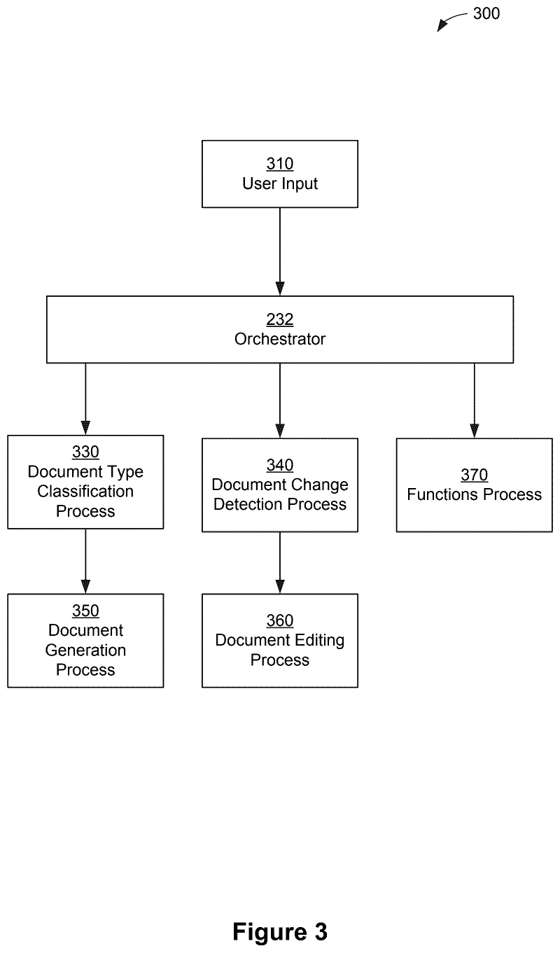

FIG. 3 illustrates a workflow 300 for handling user input in accordance with some implementations. In some implementations, the computer system 100 receives user input 310 (e.g., via a user interface 110 for the document authoring application 230). In response to receiving the user input 310, the computer system 100 launches an orchestrator 232, which runs in the background. The orchestrator 232 is responsible for triggering new processes and functions within the document authoring application 230 and externally as new user inputs are received. In response to receiving the user input 310, the orchestrator 232 can choose to perform any of: (i) trigger a document type classification process 330 (which is performed by the document classifier 234) prior to initiating a document generation process 350; (ii) trigger a document change detection process 340 prior to initiating an editing process 360 (e.g., the document editing workflow 360); and (iii) trigger a functions process 370 that utilizes the functions module 233 to call one or more external functions to perform tasks such as retrieve information or generate multi-media content (e.g., voice, images or videos, analytics, charts and graphs). In another example, the one or more external functions may include functions that support the document type classification process 330 (also referred to as a document type classification workflow) and/or or document generation process 350 (also referred to as a document generation workflow). In some implementations, the user input 310 is classified as either a request for generating content for a new document or as a user edit to existing content for a document based on the interface at which the user input is received. In some implementations, the user input 310 is classified as either a request for generating content for a new document or as a user edit to existing content for a document based on the language included in the user input (e.g., according to a user specified command verb). In some implementations, the user input 310 is classified as either a request for generating content for a new document or as a user edit to existing content for a document based on user selection of an option to start a new document (or generate new content or edit existing content).

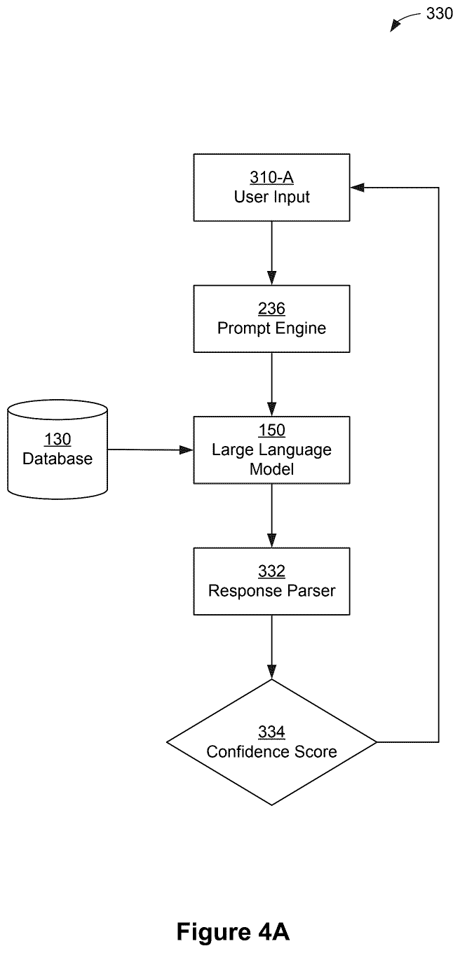

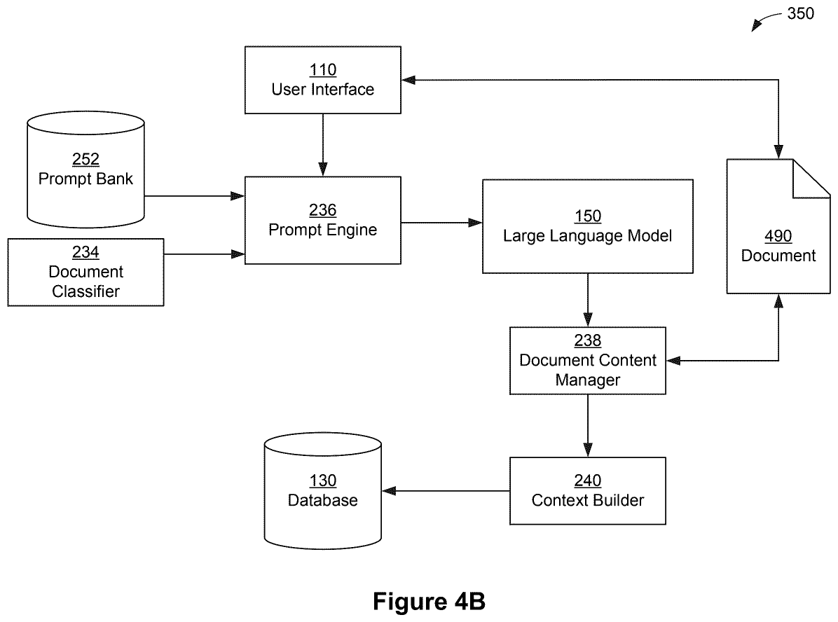

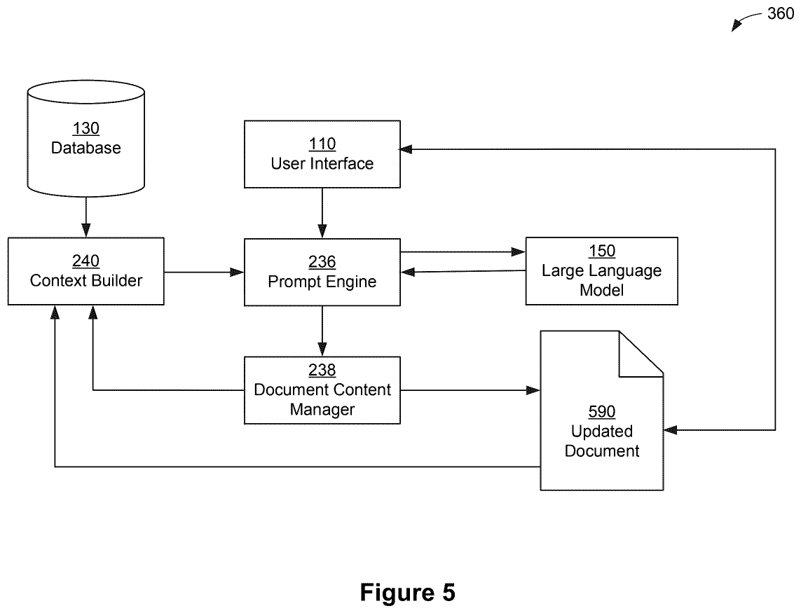

The workflow begins with the user input 310, which is received and processed by the orchestrator 232. Upon receiving the user input 310, the orchestrator 232 directs the input to either the document type classification workflow 330, a functions process 370 with updated condiment context 254, the document change detection process 340, or a combination of these processes (e.g., one or more of these processes can be performed concurrently to one another). Within the document type classification workflow 330, the document classifier 234 analyzes the user input 310 to determine the type of document requested by the user. The document type classification workflow 330 is described below with respect to FIG. 4A and is not repeated here for brevity. If a new document is to be generated, the document generation workflow 350 is initiated, details of which are provided below with respect to FIG. 4B and are not repeated here for brevity. Alternatively, if the input is identified as an edit to existing content within the document change detection process 340 (also referred to as a document change detection workflow), the document editing workflow 360 (also referred to as a document editing process) is initiated. The document editing workflow 360 is described below with respect to FIG. 5 and is not repeated here for brevity. This workflow ensures that user inputs are accurately interpreted and directed to the appropriate processes, facilitating efficient document generation and editing.

FIG. 4A is a block diagram of a document type classification workflow 330 (also referred to as a document type determination workflow, a document type determination process, or a document type classification process) in accordance with some implementations. The document type classification workflow 330 corresponds to the document type classification process 330 described above with respect to FIG. 3. In some implementations, such as when the user input 310 is determined to be an initial user input 310-A that corresponds to a request to generate a new document, the orchestrator 232 launches the document classifier 234 to determine a document type based on the user input 310-A (e.g., classify what type of document the user input 310-A is requesting). The prompt engine 236 receives the user input 310-A and generates one or more prompts that asks the large language model 150 to identify a document type based on the user input 310-A. The large language model 150 references database 130 and provides a document type. The response parser 332 receives the document type from the large language model 150 and evaluates the response based on one or more criteria that the large language model response (e.g., the output from the large language model 150) is required to meet. The response parser 332 then generates a confidence score 334 for the document type identified by the large language model 150. In some implementations, such as when the confidence score is below a predetermined threshold value, the document type is determined to be “non-deterministic.” In such cases, the prompt engine 236 may generate new prompt(s) to improve the response generated by the large language model 150. The document authoring application 230 may also ask the user to provide additional inputs (e.g., more information or more details) prior to generating the new prompt(s). This process may be repeated until the response output by the large language model 150 reaches a threshold value. In some implementations, such as when the confidence score 334 is equal to or greater than the threshold value, the document type is determined to be “deterministic.” This workflow ensures that the document type is accurately determined so that content generated in the document generation workflow 350 is relevant and reliable.

FIG. 4B is a block diagram of a document generation workflow 350 (also referred to as a document generation process) in accordance with some implementations. Once the document type has been determined (as described above with respect to FIG. 4A), a document generation workflow 350 is launched to generate content for a new document based on the initial user input 310-A. The initial user input 310-A is received at the user interface 110, and the prompt engine 236 receives the initial user input 310-A. The prompt engine requests the determined document type for this initial user input 310-A from the document classifier 234. The prompt engine 236 also requests templates from the prompt bank 252 that correspond to (e.g., are relevant to) the determined document type for the initial user input 310-A. The prompt engine 236 generates a first set of one or more prompts based on the initial user input 310-A and the templates retrieved from the prompt bank 252 for this document type. The first set of one or more prompts is provided to the large language model 150, and content generated by the large language model 150 based on the first set of one or more prompts is output to the document content manager 238. The document content manager 238 analyzes the content output from the large language model 150 and organizes the content for presentation to a user. In some implementations, the document content manager 238 utilizes a document template for the determined document type in order to properly organize the content output from the large language model 150 into the document 490. The document content is presented to the user via the user interface 110. Additionally, the context builder 240 receives the document 490 and generates context for the document 490. The context for the document content is stored in the database 130.

In some implementations, the document content 490 is presented to the user in an editable user interface in a template that resembles a document. For example, the document content may include text, numbers, and/or diagrams (e.g., figures or pictures) that are arranged in the format of a document (e.g., a book report or a patent application). In some implementations, the document content is arranged into sections based on the document template. For example, a first portion of the document content may be presented as part of a “background” section and a second portion of the document content may be presented as part of a “results” section. In some implementations, the document content is presented as a whole document. For example, the user may choose to download the document content into as a document file format (for example, a DOCX file or a PDF file).

In some implementations, the prompt engine 236 utilizes the large language model 150 to generate the one or more prompts based on the user input 310-A. For example, a document that describes a fantasy landscape with floating mountains (based on user inputs) may have a document type classified as a children's fantasy book. The prompt engine 236 may request the large language model 150 to generate prompts to describe different types of trees or rock formation on the floating mountains using the document context. Such generated prompts may then be fed back into the large language model 150 to come up with descriptions of landscape features to be presented to the user.

In some implementations, the prompt engine 236 generates one or more prompts that are part of an agentic prompting process that prompts the large language model 150 more than once. The one or more prompts may be delivered to the large language model 150 consecutively and subsequent prompts may use output(s) from the large language model 150 from previous prompts in order to revise or improve the quality and relevance of the output from the large language model 150. Such processes can significantly improve the quality of the content provided by the large language model 150 and used as document content. In some embodiments, such as in an agentic process, the prompt engine 236 may leverage tools and functions (e.g., via the functions process 370) within the orchestrator 232.

For example, a user may provide, as initial user input 310-A, a set of claims for a patent application, a disclosure document regarding an invention, and figures corresponding to the invention. The system identifies, via the document classifier 234, that the initial user input 310-A is a request to generate a patent application, and the prompt engine 236 generates one or more prompts for the large language model 150 using a template for a patent application. Thus, the one or more prompts may include, for example, a prompt that says “write an abstract for (claim 1). The abstract must rephrase the provided text with proper grammar and sentence structure, and must be no more than 150 words in length”, and another prompt that says “write a background section for a patent application for a (invention). The background section should include a brief overview of conventional methods in the field.” Upon receiving output from the large language model 150, the document content manager 238 organizes the content into relevant sections of a patent application. The document content manager 238 utilizes a patent application template to organize the content appropriately. The document content manager 238 may present the output from the large language model 150 that is provided in response to a prompt requesting an abstract in the abstract section of the patent application document, and the output from the large language model 150 that is generated in response to a prompt requesting a background section for the field of the invention is presented as part of the background section of the patent application document. Additionally, the system may recognize elements and reference numbers from the disclosure document and figures and generate (via the prompt engine 236 and the large language model 150) a description of the figures that can be used in the patent application. Thus, using the initial user input 310-A, the system can generate content for a patent application.

FIG. 5 is a block diagram of a document editing workflow 360 in accordance with some implementations. Once the user input 310 is determined to be a user edit to existing document content (or an existing document), a document editing workflow 360 is launched to assist the user in editing the document content. User edits to the document content are received at the user interface 110 as user inputs (e.g., user input 310). The prompt engine 236 receives the user edit and requests context for this document from the context builder 240. The context builder 240 retrieves the context for this document from the database 130 and provides the context to the prompt engine 236. The prompt engine 236 updates the template for this document based on the context and identifies differences between content in the current document and content in the user edits. The prompt engine 236 utilizes the updated template to identify which portions of the document (e.g., which portions of the document content) may need to be changed based on the user edit. In some implementations, the prompt engine 236 identifies which portions of the document require changes based on the document context and/or the document template. Using the user edit and the document context, the prompt engine 236 generates a second set of one or more prompts for the large language model 150. The prompt engine 236 receives the content output from the large language model 150 and sends the content output from the large language model 150 to the document content manager 238. The prompt engine 236 also sends information regarding which portions of the document need to be updated to the document content manager 238. The document content manager 238 arranges the content output from the large language model 150 based on the information regarding which portions of the document need to be updated (as determined by the prompt engine 236), and generates an updated document 590, which includes the original document content (e.g., the original document 490), and one or more suggestions (e.g., recommendations) that suggest (e.g., recommend) changes to the document at specified positions in the document. Thus, when a user provides an edit at one location in the document (e.g., one part of the document content), the system automatically identifies other portions of the document (e.g., other parts of the document content) that need revision (e.g., insertions, updates, or deletions) in order to maintain consistency within the document.

In some implementations, the template for the document is also automatically updated as user inputs (e.g., user edits and user acceptance or rejection of suggestions) are received. Thus, each generated document has a customized and dynamic template that evolves with the document and its content.

In some implementations, the context builder 240 automatically updates the document context as user inputs (e.g., user edits and user acceptance or rejection of suggestions) are received. Since the document context is used by the prompt engine 236 for generating prompts, the development of the document context in accordance with changes to the document and its content also allows the prompt engine 236 to generate increasingly better prompts. Ideally, content from the large language model 150 improves as the system better understands the context and style of the document.

For example, the updated document 590 may include a suggestion in the fifth paragraph of the document to remove content that is inconsistent with the user edit. In another example, the updated document 590 may include a suggestion to add content to the last paragraph of the document to include new content that was introduced in the user edit.

As the user accepts or rejects the suggestions in the updated document 590, the document content manager 238 keeps track of the user's responses (to accept or reject suggestions) as well as which portions of the document are user-generated and which portions of the document are generated using content output from the large language model 150.

As the user accepts or rejects the suggestions in the updated document 590, the document and the user responses are sent to the context builder 240 and the context builder 240 updates the context for the document 490. The new or updated context for the document is stored in the database 130.

In another example, a fiction writer may decide to rename a character from “Chris” to “Krista” and change the gender of the character from male to female. Conventional document editing and content creation systems would not be able to assist the writer in identifying portions of the story that require change, and propagating these changes throughout the story without the user manually re-reading and editing the work. In this example, the methods and systems described in FIG. 5 would automatically identify all instances of: (i) the name “Chris” and suggest changing to “Krista,” (ii) instances of the pronoun “he” when referring to Chris and suggest changing the text to “her,” and (iii) identify portions of the story that include references to the character that are potentially gender specific. For example, the system may identify a portion of the story that describes Chris as “a strong young lad from Palo Alto” and changing the text to “a strong young woman from Palo Alto.” The writer may choose to approve or reject this suggested change to the text. Following this example, the writer may decide that Krista will be wearing shorts instead of pants. The system may identify a portion of the story where Krista gets “her pant leg caught on a branch” and suggest changing the text to “the branch scraped the side of leg, drawing a small amount of blood. Krista regrets choosing her shorts over her hiking pants that day,” and the writer may choose to approve or reject this suggested change to the text.

In yet another example, a lawyer preparing a patent application may decide to change the wording in claim 1 to refer to an “illumination source” instead of a “light bulb”. Without the assistance of the systems and methods described herein, the lawyer would have to find and revise portions of the patent application that refer to the “light bulb” and make the edits, as well as edit any portions that recite the claims. However, with the use of the systems and methods described herein, the system may immediately identify, based on the template for patent applications, that at least the abstract and the summary sections (which recite language from independent claims) of the patent application will need to be revised. Additionally, the system may identify portions of the text that discuss details about the light bulb and suggest rephrasing them as examples.

As shown, the system and methods described herein have a level of sophistication that extends far beyond a simple “find and replace” functionality. The system utilizes document context generated by the context builder 240 to understand the main points of the document, utilizes the document template to understand where to appropriately place content, and utilizes the prompt engine 236 and large language model 150 to generate new content that extends beyond rephrasing or inserting the user's edits into a document.

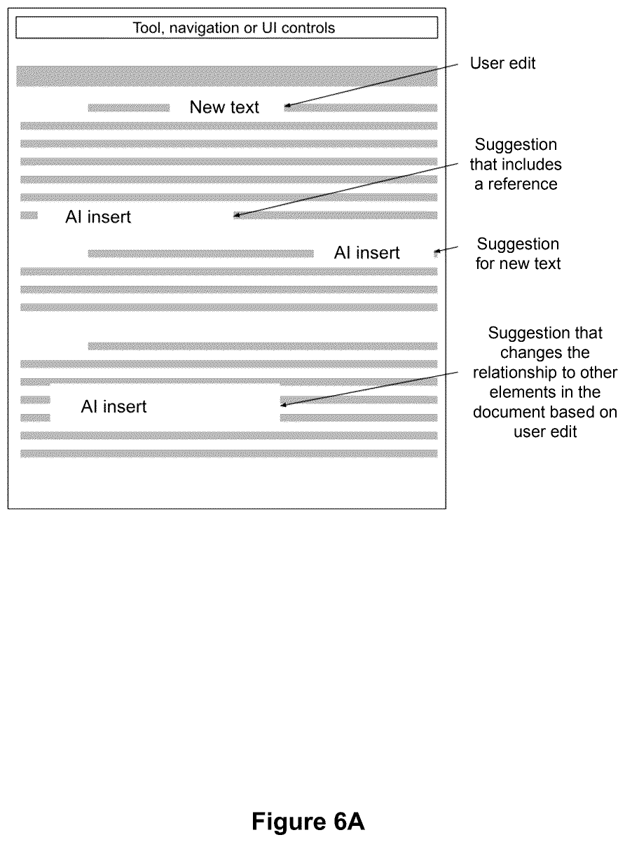

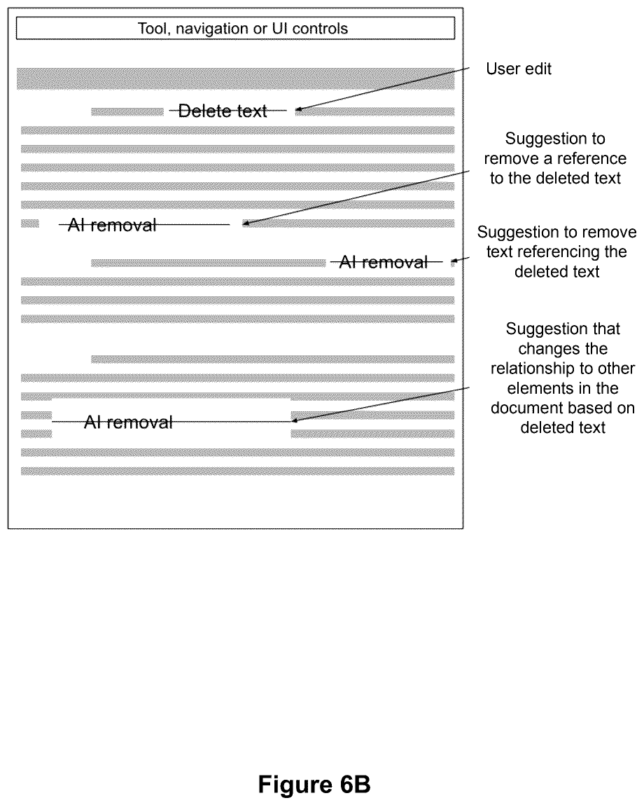

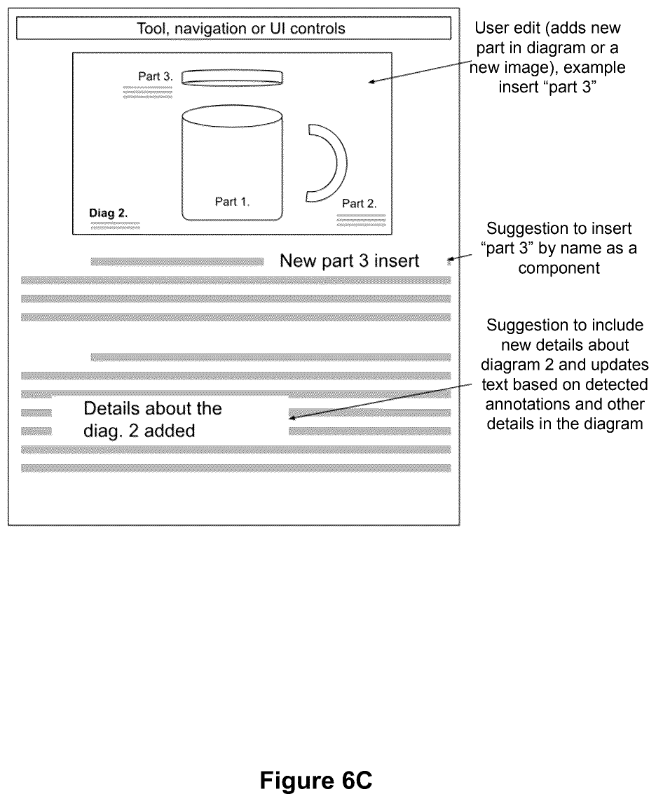

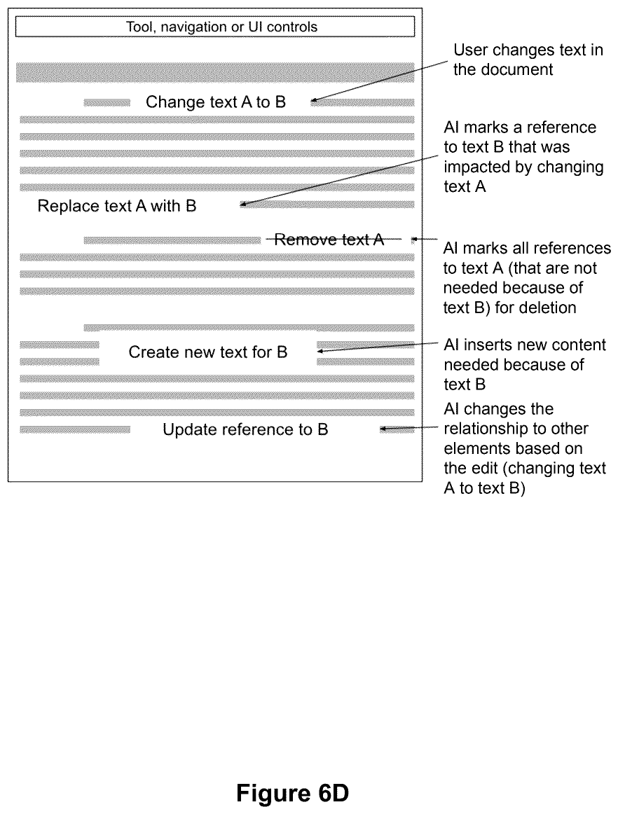

FIGS. 6A-6D illustrate examples of user interfaces for receiving user input and presenting recommendations to a user in accordance with some implementations.

FIG. 6A provides an example of receiving a user edit in the form of new text being inserted in a document and providing suggested changes throughout the document. In this example, a first suggestion includes adding a reference to the same paragraph as the user edit, a second suggestion includes adding new text to another paragraph that is different from the paragraph that the new text from the user was input into, and a third suggestion that changes the relationship between different elements in the document in accordance with the user edit.

FIG. 6B provides an example of receiving a user edit in the form of deleted text in a document and providing suggested changes throughout the document. In this example, a first suggestion includes removing a reference in the same paragraph as the user edit, a second suggestion includes removing text in another paragraph that is different from the paragraph that the user deleted text from, and a third suggestion that changes the relationship between different elements in the document in accordance with the deleted text.

FIG. 6C provides an example of receiving a user edit in the form of adding a new element in a diagram (e.g., a figure or a picture) in a document and providing suggested changes throughout the document. In this example, the user has added a new part, “part 3,” in Diagram 2 within the document. In this example, a first suggestion includes inserting text referring to “Part 3” as a component. A second suggestion includes adding new details about diagram 2 and updating the text based on detected annotations and other details in the diagram.

FIG. 6D provides an example of receiving a user edit where “text A” is changed to “text B” in a document and providing suggested changes throughout the document. In this example, a first suggestion includes changing a reference that discusses “text A” to instead to refer to “text B”, a second suggestion includes removing content referring to “text A” in the document, a third suggestion to insert new content based on the introduction of “text B” in the user edit, and a fourth suggestion that changes the relationship between different elements in the document in accordance with the change from “text A” to “text B.” For example, if a document were updated from “a table made of metal” to “a table made of wood,” text referring to a “metal table” would be marked for change to a “wooden table.” Additionally, all references that describe properties of the table that are attributed to it being made out of metal would be removed (such as, “may rust if left in the rain”), and new properties of the table due to its wooden composition may be added (such as “the wood may be made out of a composite wood or a hardwood, such as Walnut, Pine, or Oak”). Additionally, text describing features that relate to the metallic nature of the table would be changed to relate to the wooden nature of the table. For example, “the table legs are welded to the table top to provide a strong connection” may be changed to “the table legs and table top are attached using Japanese joinery, requiring no tools to assemble.”

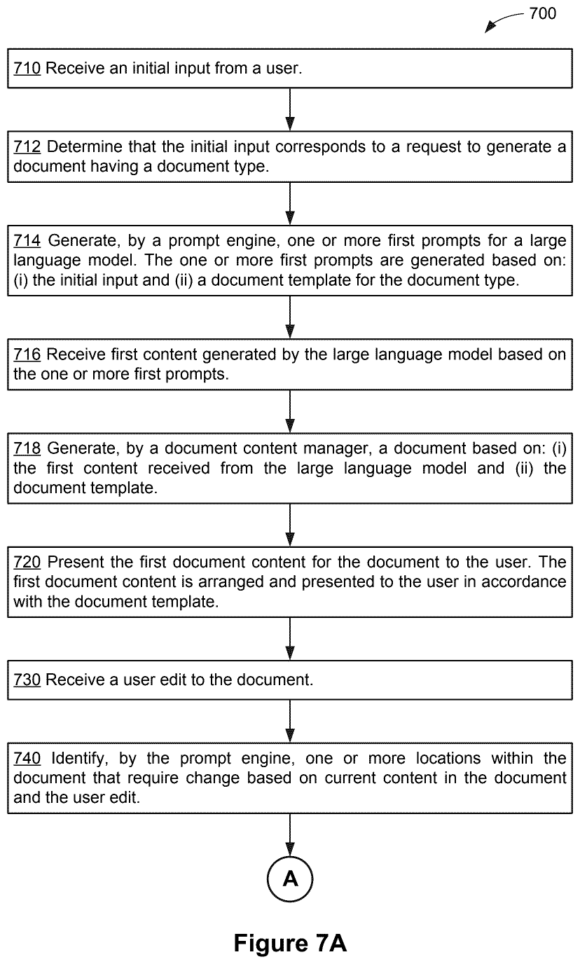

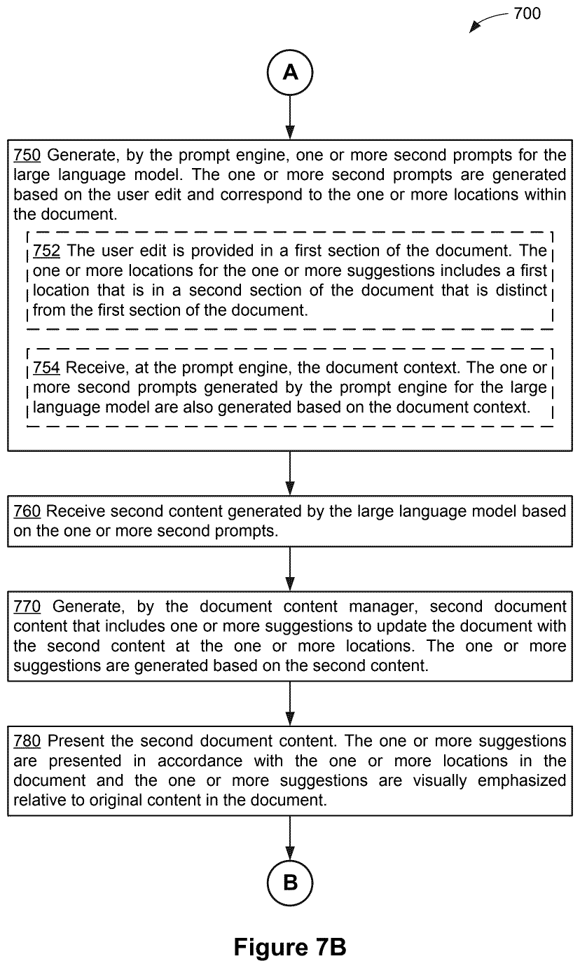

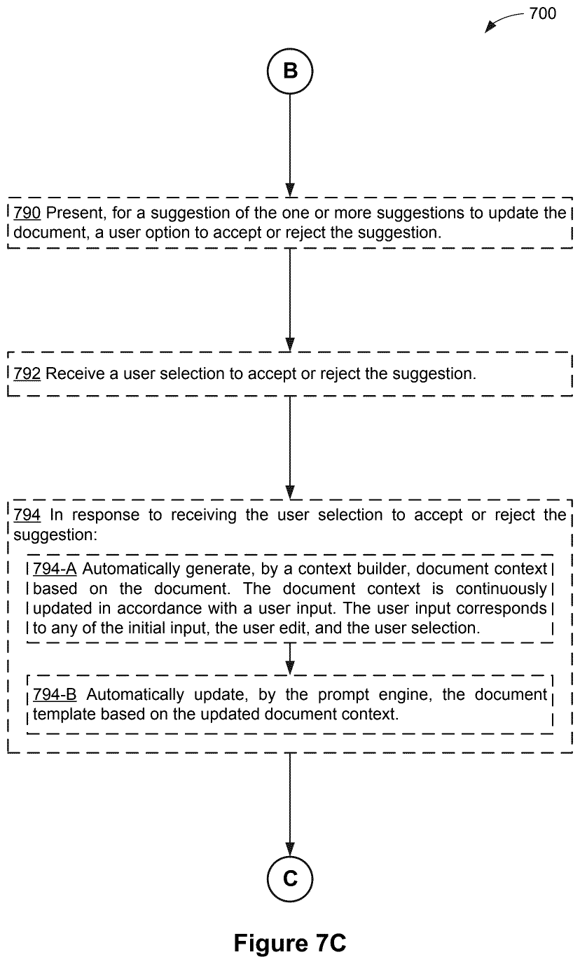

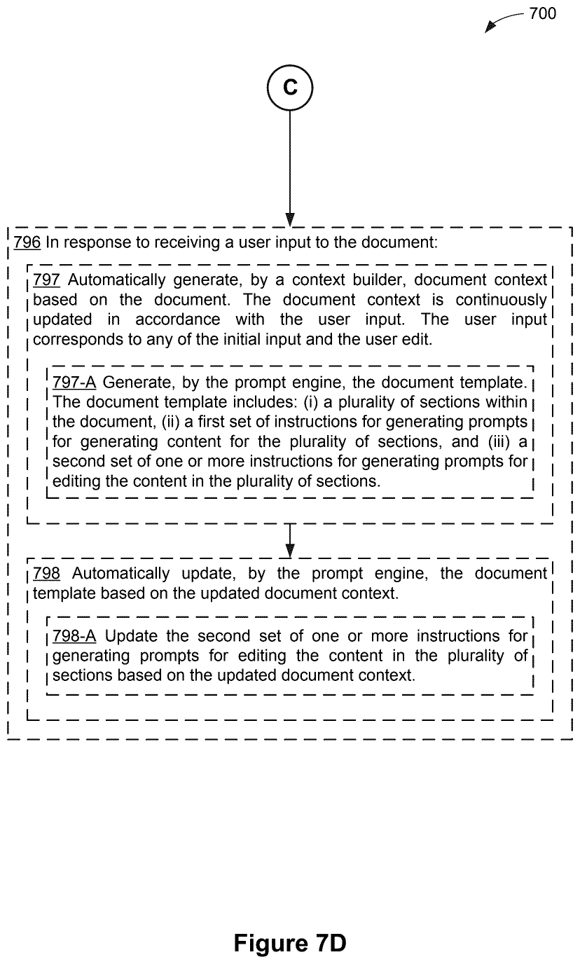

FIGS. 7A-7D provide a flowchart of a method 700 for cascading document updates in accordance with some implementations. The method 700 is performed at a computing device having memory and one or more processors. The method 700 includes receiving (step 710) an initial input 310-A from a user; determining (step 712) that the initial input 310-A corresponds to a request to generate a document having a document type; and generating (step 714), by a prompt engine 236, one or more first prompts for a large language model 150. The one or more first prompts are generated based on: (i) the initial input 310-A and (ii) a document template for the document type. The method 700 further includes receiving (step 716) first content generated by the large language model 150 based on the one or more first prompts; generating (step 718), by a document content manager, a document 490 based on: (i) the first content received from the large language model 150 and (ii) the document template; and presenting (step 720) the first document content for the document 490 to the user. The first document content is arranged and presented to the user in accordance with the document template. The method 700 also includes: receiving (step 730) a user edit 310 to the document 490; identifying (step 740), by the prompt engine 236, one or more locations within the document 490 that require change based on current content in the document 490 and the user edit; generating (step 750), by the prompt engine 236, one or more second prompts for the large language model 150. The one or more second prompts are generated based on the user edit and correspond to the one or more locations within the document 490.

In some implementations, the user edit is provided (step 752) in a first section of the document. The one or more locations for the one or more suggestions includes a first location that is in a second section of the document that is distinct from the first section of the document.

In some implementations, the method 700 further includes receiving (step 754), at the prompt engine 236, the document context. The one or more second prompts generated by the prompt engine 236 for the large language model 150 are also generated based on the document context.

The method further includes receiving (step 760) second content generated by the large language model 150 based on the one or more second prompts and generating (step 770), by the document content manager 238, second document content that includes one or more suggestions to update the document 490 with the second content at the one or more locations. The one or more suggestions are generated based on the second content. The method also includes presenting (step 780) the second document content. The one or more suggestions are presented in accordance with the one or more locations in the document 490 and the one or more suggestions are visually emphasized relative to original content in the document 490.

In some implementations, the method 700 further includes presenting (step 790), for a suggestion of the one or more suggestions to update the document 490, a user option to accept or reject the suggestion and receiving (step 792) a user selection to accept or reject the suggestion. In some implementations, the method 700 also includes (step 794), in response to receiving the user selection to accept or reject the suggestion: automatically generating (step 794-A), by a context builder 240, document context based on the document. The document context is continuously updated in accordance with a user input. The user input 310 corresponds to the initial input 310-A, the user edit, and/or the user selection. The method 700 also includes (step 794), in response to receiving the user selection to accept or reject the suggestion: automatically updating (step 794-B), by the prompt engine 236, the document template based on the updated document context.

In some implementations, the method 700 further includes (step 796), in response to receiving a user input 310 (e.g., user edit) to the document 490: automatically generating (step 797), by a context builder 240, document context based on the document 490. The document context is continuously updated in accordance with the user input 310. The user input 310 corresponds to any of the initial input 310-A and/or the user edit. The method 700 also includes (step 796) in response to receiving a user input 310 to the document 490: automatically updating (step 798), by the prompt engine 236, the document template based on the updated document context.

In some implementations, automatically generating document context based on the document 490 by a context builder 240 includes (step 797) generating (step 797-A), by the prompt engine 236, the document template. The document template includes: (i) a plurality of sections within the document 490, (ii) a first set of instructions for generating prompts for generating content for the plurality of sections, and (iii) a second set of one or more instructions for generating prompts for editing the content in the plurality of sections.

In some implementations, automatically updating the document template based on the updated document context by the prompt engine 236 includes (step 798) updating (step 798-A) the second set of one or more instructions for generating prompts for editing the content in the plurality of sections based on the updated document context.

In some implementations, the initial input 310-A is received at a first user interface and the first content is presented to the user at a second user interface that is different from the first user interface (e.g., a different screen, a different web page, or a different window). The user edit is received at the second user interface, and the updated document is presented to the user at the second user interface. For example, the document authoring application 230 may include a user interface 110 with different pages or different sections. A first user interface that includes fields for the user to enter information relevant to creating a new document may be presented to a user so that the user may type, link, or upload relevant information, and a second user interface that includes the generated content (in response to the initial inputs 310-A provided by the user in the first user interface) is presented to the user. In some implementations, the second user interface is an editable interface that can receive user edits. In some implementations, the one or more suggestions (generated from outputs from the large language model 150 in response to the one or more second prompts provided by the prompt engine 236) are presented to the user in the second user interface alongside any user edits.

In some implementations, the initial input 310-A includes a disclosure document for an invention, one or more references corresponding to the invention (including files and/or links), one or more claims corresponding to the invention, and/or one or more figures corresponding to the invention. In some instances, the document type is a patent application, and the document template is a template for a patent application. In some implementations, the initial input 310-A corresponds to a request to generate content for a patent application. In some implementations, the initial input 310-A corresponds to a request to generate content for a patent application in accordance with the one or more claims provided by the user as part of the initial input 310-A.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method performed at a computing device having memory and one or more processors, the method comprising:
receiving an initial input from a user;
determining that the initial input corresponds to a request to generate a document having a document type;
generating, by a prompt engine, one or more first prompts for a large language model, wherein the one or more first prompts are generated based on (i) the initial input and (ii) a document template for the document type;
receiving first content generated by the large language model based on the one or more first prompts;
generating, by a document content manager, a document based on (i) the first content received from the large language model and (ii) the document template;
presenting the first content for the document to the user, wherein the first content is arranged and presented to the user in accordance with the document template;
receiving a user edit to the document;
identifying, by the prompt engine, one or more locations within the document that require change based on current content in the document and the user edit;
generating, by the prompt engine, one or more second prompts for the large language model, wherein the one or more second prompts are generated based on the user edit and correspond to the one or more locations within the document;
receiving second content generated by the large language model based on the one or more second prompts;
generating, by the document content manager, an updated document that includes one or more suggestions to update the document with the second content at the one or more locations, the one or more suggestions generated based on the second content; and
presenting the updated document in accordance with the one or more locations in the document, with the one or more suggestions visually emphasized relative to original content in the document.

2. The method of claim 1, wherein:
the user edit is provided in a first section of the document;
the one or more locations for the one or more suggestions include a first location that is in a second section of the document that is distinct from the first section of the document.

3. The method of claim 2, further comprising:
presenting, for a suggestion of the one or more suggestions to update the document, a user option to accept or reject the suggestion;
receiving a user selection to accept or reject the suggestion; and
in response to receiving the user selection to accept or reject the suggestion:
automatically generating, by a context builder, document context based on the document, wherein the document context is continuously updated in accordance with a user input, the user input corresponding to any of the initial input, the user edit, and the user selection; and
automatically updating, by the prompt engine, the document template based on the updated document context.

4. The method of claim 1, further comprising, in response to receiving a user input to the document:
automatically generating, by a context builder, document context based on the document, wherein:
the document context is continuously updated in accordance with the user input; and
the user input corresponds to any of the initial input and the user edit; and
automatically updating, by the prompt engine, the document template based on the updated document context.

5. The method of claim 4, wherein:
generating the document includes generating, by the prompt engine, the document template;
the document template includes: (i) a plurality of sections within the document, (ii) a first set of instructions for generating prompts for generating content for the plurality of sections, and (iii) a second set of one or more instructions for generating prompts for editing the content in the plurality of sections; and
automatically updating the document template based on the updated document context includes updating the second set of one or more instructions for generating prompts for editing the content in the plurality of sections based on the updated document context.

6. The method of claim 4, further comprising:
receiving, at the prompt engine, the document context, wherein the one or more second prompts generated by the prompt engine for the large language model are also generated based on the document context.

7. The method of claim 1, wherein:
the initial input is received at a first user interface;
the first content is presented to the user at a second user interface that is different from the first user interface;
the user edit is received at the second user interface; and
the updated document is presented to the user at the second user interface.

8. The method of claim 1, wherein:
the initial input includes one or more of: a disclosure document for an invention, one or more references corresponding to the invention, one or more claims corresponding to the invention, and/or one or more figures corresponding to the invention;
the document type is a patent application; and
the document template is a template for a patent application.

9. A computing device, comprising:
one or more processors;
memory;
a display; and
one or more programs stored in the memory and configured for execution by the one or more processors, the one or more programs comprising instructions for:
receiving an initial input from a user;
determining that the initial input corresponds to a request to generate a document having a document type;
generating, by a prompt engine, one or more first prompts for a large language model, wherein the one or more first prompts are generated based on (i) the initial input and (ii) a document template for the document type;
receiving first content generated by the large language model based on the one or more first prompts;
generating, by a document content manager, a document based on (i) the first content received from the large language model and (ii) the document template;
presenting the first content for the document to the user, wherein the first content is arranged and presented to the user in accordance with the document template;
receiving a user edit to the document;
identifying, by the prompt engine, one or more locations within the document that require change based on current content in the document and the user edit;
generating, by the prompt engine, one or more second prompts for the large language model, wherein the one or more second prompts are generated based on the user edit and correspond to the one or more locations within the document;
receiving second content generated by the large language model based on the one or more second prompts;
generating, by the document content manager, an updated document that includes one or more suggestions to update the document with the second content at the one or more locations, the one or more suggestions generated based on the second content; and
presenting the updated document in accordance with the one or more locations in the document, with the one or more suggestions visually emphasized relative to original content in the document.

10. The computing device of claim 9, wherein:
the user edit is provided in a first section of the document;
the one or more locations for the one or more suggestions include a first location that is in a second section of the document that is distinct from the first section of the document.

11. The computing device of claim 10, further comprising:
presenting, for a suggestion of the one or more suggestions to update the document, a user option to accept or reject the suggestion;
receiving a user selection to accept or reject the suggestion; and
in response to receiving the user selection to accept or reject the suggestion:
automatically generating, by a context builder, document context based on the document, wherein the document context is continuously updated in accordance with a user input, the user input corresponding to any of the initial input, the user edit, and the user selection; and
automatically updating, by the prompt engine, the document template based on the updated document context.

12. The computing device of claim 9, further comprising, in response to receiving a user input to the document:
automatically generating, by a context builder, document context based on the document, wherein:
the document context is continuously updated in accordance with the user input; and
the user input corresponds to any of the initial input and the user edit; and
automatically updating, by the prompt engine, the document template based on the updated document context.

13. The computing device of claim 12, wherein:
generating the document includes generating, by the prompt engine, the document template;
the document template includes: (i) a plurality of sections within the document, (ii) a first set of instructions for generating prompts for generating content for the plurality of sections, and (iii) a second set of one or more instructions for generating prompts for editing the content in the plurality of sections; and
automatically updating the document template based on the updated document context includes updating the second set of one or more instructions for generating prompts for editing the content in the plurality of sections based on the updated document context.

14. The computing device of claim 12, further comprising:
receiving, at the prompt engine, the document context, wherein the one or more second prompts generated by the prompt engine for the large language model are also generated based on the document context.

15. A non-transitory computer-readable storage medium storing one or more programs configured for execution by a computing device having one or more processors, memory, and a display, the one or more programs comprising instructions for:
receiving an initial input from a user;
determining that the initial input corresponds to a request to generate a document having a document type;
generating, by a prompt engine, one or more first prompts for a large language model, wherein the one or more first prompts are generated based on (i) the initial input and (ii) a document template for the document type;
receiving first content generated by the large language model based on the one or more first prompts;
generating, by a document content manager, a document based on (i) the first content received from the large language model and (ii) the document template;
presenting the first content for the document to the user, wherein the first content is arranged and presented to the user in accordance with the document template;
receiving a user edit to the document;
identifying, by the prompt engine, one or more locations within the document that require change based on current content in the document and the user edit;
generating, by the prompt engine, one or more second prompts for the large language model, wherein the one or more second prompts are generated based on the user edit and correspond to the one or more locations within the document;
receiving second content generated by the large language model based on the one or more second prompts;
generating, by the document content manager, an updated document that includes one or more suggestions to update the document with the second content at the one or more locations, the one or more suggestions generated based on the second content; and
presenting the updated document in accordance with the one or more locations in the document, with the one or more suggestions visually emphasized relative to original content in the document.

16. The non-transitory computer-readable storage medium of claim 15, wherein:
the user edit is provided in a first section of the document;
the one or more locations for the one or more suggestions include a first location that is in a second section of the document that is distinct from the first section of the document.

17. The non-transitory computer-readable storage medium of claim 16, further comprising:
presenting, for a suggestion of the one or more suggestions to update the document, a user option to accept or reject the suggestion;
receiving a user selection to accept or reject the suggestion; and
in response to receiving the user selection to accept or reject the suggestion:
automatically generating, by a context builder, document context based on the document, wherein the document context is continuously updated in accordance with a user input, the user input corresponding to any of the initial input, the user edit, and the user selection; and
automatically updating, by the prompt engine, the document template based on the updated document context.

18. The non-transitory computer-readable storage medium of claim 15, further comprising, in response to receiving a user input to the document:
automatically generating, by a context builder, document context based on the document, wherein:
the document context is continuously updated in accordance with the user input; and
the user input corresponds to any of the initial input and the user edit; and
automatically updating, by the prompt engine, the document template based on the updated document context.

19. The non-transitory computer-readable storage medium of claim 18, wherein:
generating the document includes generating, by the prompt engine, the document template;
the document template includes: (i) a plurality of sections within the document, (ii) a first set of instructions for generating prompts for generating content for the plurality of sections, and (iii) a second set of one or more instructions for generating prompts for editing the content in the plurality of sections; and
automatically updating the document template based on the updated document context includes updating the second set of one or more instructions for generating prompts for editing the content in the plurality of sections based on the updated document context.

20. The non-transitory computer-readable storage medium of claim 18, further comprising:
receiving, at the prompt engine, the document context, wherein the one or more second prompts generated by the prompt engine for the large language model are also generated based on the document context.
